(19) United States
(12) Patent Application Publication
(10) Pub. No.: US 2003/0047370 A1
(43) Pub. Date: Mar. 13, 2003

(54) Bumper device for existing trains

(76) Inventor: John H. Gibbs, Mooresville, IN (US)

Correspondence Address: John H. Gibbs, 333 South Clay St, Mooresville, IN, 46158, US

(21) Appl. No.: 10/268,489

(22) Filed: Oct. 11, 2002

Related U.S. Application Data
(62) Division of application No. 09/233,722, filed on Dec. 30, 1998.

(51) Int. Cl. B60R 21/00

(52) U.S. Cl. 180/271

(57) ABSTRACT

This invention is a bumper device for the front part of an existing train. A railroad car coupler can attach or detach the bumper device. The most important feature of this bumper device is; if a train collides with a vehicle at a cross intersection, the bumper device distributes the train's inertial force into a pressure force over some portion of the vehicle's surface area. By this action; the vehicle will incur less structural damage than just metal to metal contact.

The three preferred versions of the bumper device are; the airbag bumper device, the spring bumper device and the starfoam bumper device. The airbag bumper device can be all one giant airbag or a collection of smaller airbags threaded together and lifted off the railroad tracks.

An individual airbag can have an inner airbag in case the outer airbag ruptures. It is also possible to fill individual airbags with a liquid that will increase the resistance of the impact force. The spring bumper device is two plates with coiled springs in-between them. The exterior plate has a larger surface area than the inner plate because it is in contact with the vehicle. The starfoam bumper device is a variation of the spring bumper device. Instead of springs in-between plates, starfoam strips is in-between structural plates. Again, the outer plate has a greater surface area than the inner plate.

### BACKGROUND

The invention relates to bumpers that minimize damage in a moving object's collision. Unlike Automobile bumpers, this bumper minimizes damage to the “other” vehicle, rather than minimizing damage to the Automobile with the bumper.

Prior Art includes: Huggins ('123) and Erdmann ('768) teach of deformable and impact absorbing bumper devices that are detachable. However both Huggins & Erdmann require a special mounting to an existing train. This invention requires no special mountings. In addition; let the cross section of the front of the device be “A” square inches and the end cross section be “B” square inches. Both Huggins & Erdmann have nearly cylinder bumper devices, so “A=B”. In the present invention, “B” is much greater than “A” so that the impact force of “A” distributes over “B”'s area. In the third point, Huggins' device is a bumper to bumper contact, not train to object contact.

Sobel ('609) or Alfes ('223) or Walker ('915) bumper device is not designed to be detached from an existing car. Furthermore, their bumper device is designed to minimize damage to the Automobile with the bumper, not to the other Automobile in the collision.

### OBJECTS AND ADVANTAGES

Accordingly, the object of this invention is to prevent the loss of life or to increase the quality of life, to individuals that have a train-vehicle accident. The advantage of this bumper device is to allow existing trains easy adaptation and not to interfere with the regular train operations.

### DESCRIPTION OF DRAWINGS

FIG. 1A shows an airbag bumper mounted on the front part of an existing train.

FIG. 1AA shows a forward view of the airbag bumper device.

FIG. 1B shows a different version of the bumper device that is either spring type or starfoam type on the front of an existing train.

FIG. 2 illustrates a close up view of an airbag bumper device.

FIG. 2A shows an airbag with an inner concentric airbag.

FIG. 3 illustrates a close up view of the spring bumper device.

FIG. 4 shows a close up view of the starfoam bumper device.

### REFERENCE LABELS OR NUMBERS

| | |
|---|---|
| 1 | Train |
| 1A | Front Part of the Train |
| 1B | Railroad Car Coupler |
| 1C | Railroad Wheels |
| 1D | Railroad Tracks |
| 1E | Train's Front View Light |
| 1F | Engineer's Front Window |
| 2 | Airbag Bumper Device |
| 2A | An Individual Airbag |
| 2B | Suspension Cable |
| 2C | Connecting Cable |
| 2D | An Inner or Internal Airbag |
| 3 | Spring Bumper Device |
| 3A | Spring |
| 4 | Starfoam Bumper Device |
| 4A | Starfoam Strips or Plates |
| 5 | Base Plate for any Bumper Device |
| 6 | Structural Plates or Boards |

### PREFERRED DESCRIPTION OF INVENTION

This is a division of Ser. No. 09/233,722, filed Dec. 30, 1998, now abandoned.

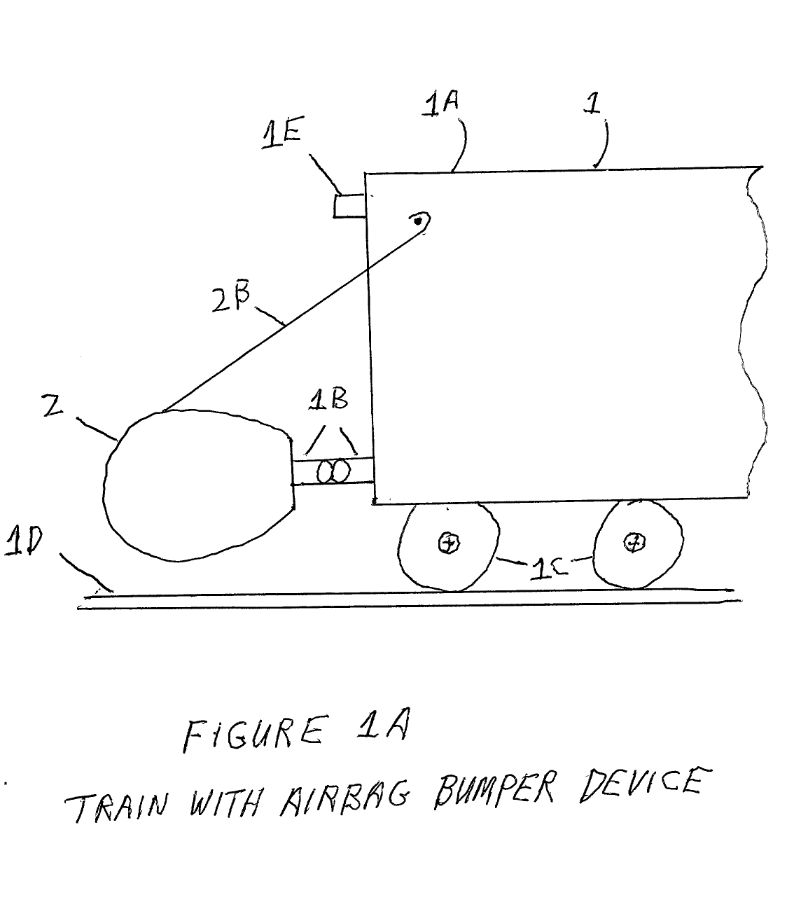

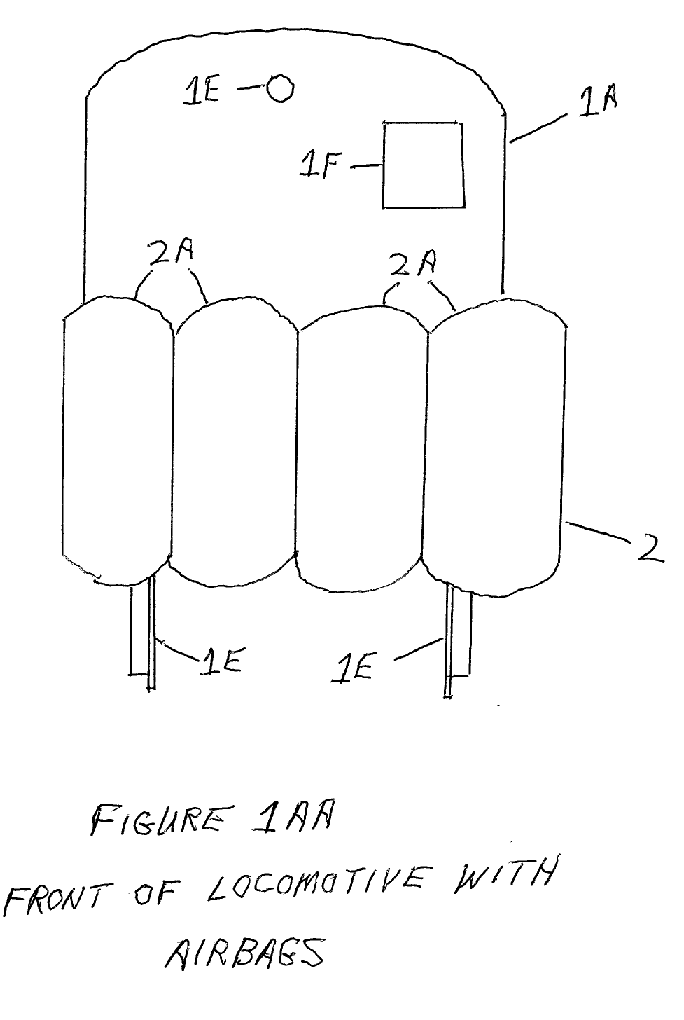

FIG. 1A shows the airbag bumper device 2 that is attached to the front end of a train 1A (usually the train's 1 engine). The train's engine 1A has wheels 1C on railroad tracks 1D. The engine's 1A light 1E is above the bumper device 2, 3 & 4 (bumper devises 3 & 4 are not shown in FIG. 1A). The bumper device 2, 3 & 4 attached to the engine 1A is by a railroad car coupler 2B. The airbag bumper device 2 is lifted up from the railroad tracks 1D by suspension cables 2B.

FIG. 1AA shows the forward view of the airbag bumper device 2 that is attached to a train's front part 1A. The Engineer's forward viewing window 1F gives a full view of the track's ahead while viewing over the bumper device 2, 3 & 4. The airbag bumper device 2 can be composed of smaller individual airbags 2A or just one giant airbag 2A.

FIG. 1B illustrates two other versions of the bumper device 3 & 4. One type of bumper device 3 uses springs to cushion the impact force, while another type of bumper device 4 uses starfoam strips to cushion the impact force. Recently, the starfoam strips have proved effective in reducing the damage caused by racecars crashing in the wall at the Indianapolis 500 mile race track.

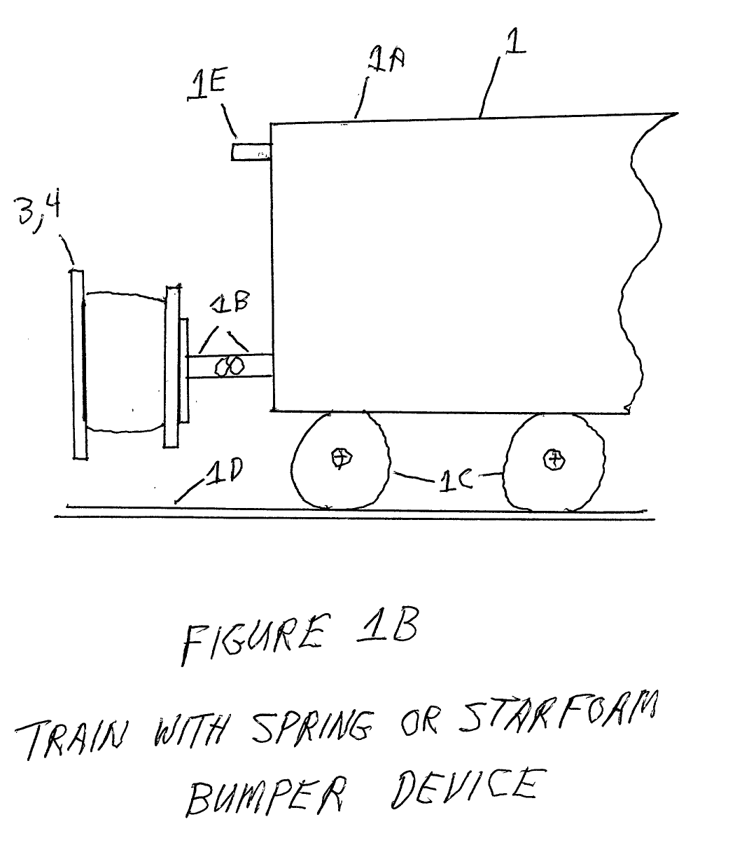

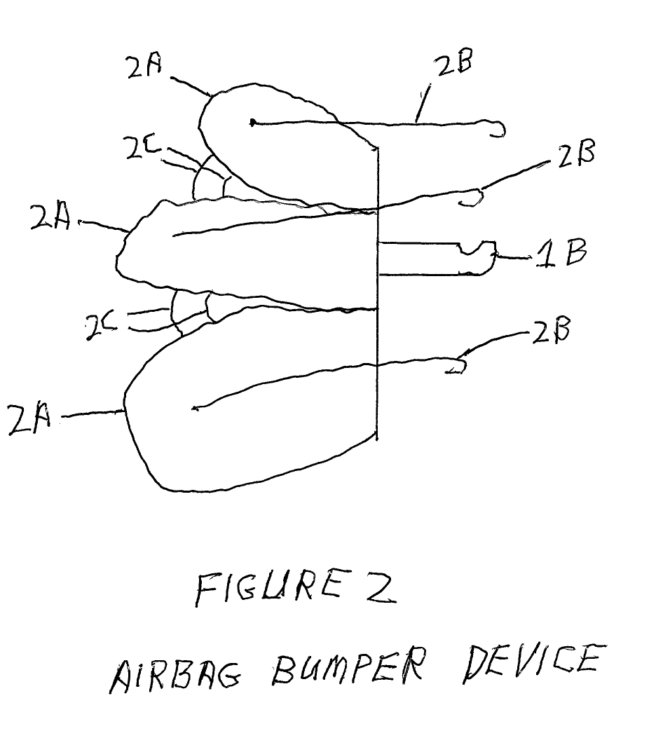

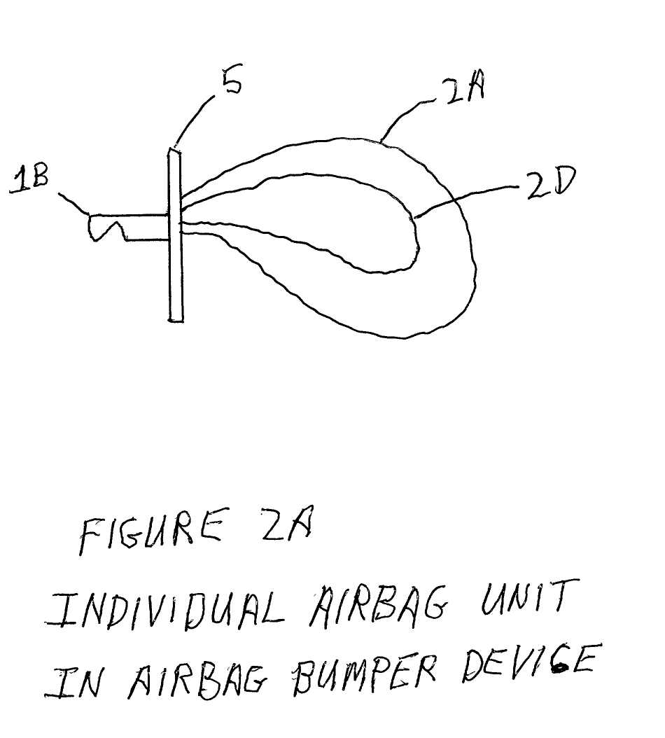

FIG. 2 shows a close up view of an airbag bumper device 2 in detail. The individual airbags 2A are connected to a base plate 5 that holds the railroad car coupler 1B. There are connecting cables 2C that binds the individual airbags 2A together. The suspension cables 2B lift the airbags 2A off the tracks 1D.

FIG. 2A shows how an individual airbag 2A might have an interior airbag 2D. If an outer airbag 2A ruptures, the inner airbag 2D would continue to apply pressure force to the impacted vehicle. It is also possible to have a series of nested inner airbags 2D (like concentric circles), rather than just one inner airbag 2D as illustrated. In addition, an inner airbag 2D might be filled with a liquid (rather than with air) to strengthen the pressure force on a vehicle.

FIG. 3 shows the spring version of the bumper device 3. The spring bumper device 3 has a base plate 5 with a railroad car coupler 1B in order to attach to a train 1. The base plate 5 has a connecting structural plate 6. An outer structural plate 6 with a larger surface area serves as the contact for impact vehicles. In-between the structural plates 6 is coiled springs 3A that absorb the impact force between the train 1 and the vehicle.

FIG. 4 shows a starfoam version of the bumper device 4 in detail. Both the spring bumper device 3 and the starfoam bumper device 4 have basically the same design structure. However, instead of using springs 3A in-between structural plates 6 in the spring bumper device 3, the starfoam bumper device 4 uses starfoam strips or plates 4A in-between structural plates 6 to absorb the impact force.

What is claimed is:

1) A bumper device that is attached to the front exterior of an existing train, comprising;
if said train collides with an vehicle at a railroad-roadway intersection, said bumper device distributes said train's impact force over said vehicle's surface area, so as, to cause less structural damage to said vehicle than a train without said bumper device;
said bumper device can be detached from said train's front exterior.

2) A bumper device that is attached to the front exterior of an existing train, as is claim 1, in addition;
said bumper device is an airbag or a plurality of airbags.

3) A bumper device that is attached to the front exterior of an existing train, as is claim 2, in addition;
any of said airbags may be comprised of a plurality of concentric airbags.

4) A bumper device that is attached to the front exterior of an existing train, as in claim 2, in addition;
any or all of said airbags can be filled with a liquid.
